(19) United States
(12) Patent Application Publication
(10) Pub. No.: US 2024/0087789 A1
(43) Pub. Date: Mar. 14, 2024

(54) Electrical component, in particular electrical coil, comprising a plurality of windings of a wire

(71) Applicant: Schlaeger Kunststofftechnik GmbH, Bayreuth (DE)

(72) Inventors: Markus KRELLNER, Bayreuth (DE); Jakob HEINRICH, Bayreuth (DE)

(21) Appl. No.: 18/263,223

(22) PCT Filed: Jan. 27, 2022
(86) PCT No.: PCT/EP2022/051931

§ 371 Date: Jul. 27, 2023

(30) Foreign Application Priority Data
Jan. 29, 2021 (DE) 10 2021 102 141.3

(51) Int. Cl. H01F 27/00; H01F 27/28; H01F 27/30

(52) U.S. Cl. CPC H01F 27/006; H01F 27/2823; H01F 27/306

(57) ABSTRACT

An electrical component, in particular an electrical coil, incudes a plurality of windings of a wire, which are wound on a main body that defines an axis, in particular a coil axis. The windings are arranged in a plurality of winding layers which are at different spacings to the axis. Additionally, at least one outer, in particular outermost, winding layer is wound directly on an inner winding layer that faces the axis of the main body, and a first winding, which is wound on the main body, and in particular makes direct contact with the main body, and the last winding, which is wound on the main body, are arranged on the same side of the main body.

The invention relates to an electrical component, in particular an electrical coil, comprising a plurality of windings of a wire, which are arranged or alternatively wound on a main body defining an axis, in particular a coil axis. Such electrical coil components are known from the prior art. In the prior art, the main body of the electrical component is wound with a wire to form windings. Here, the winding typically takes place in such a way that the windings are wound in immediate succession along the coil axis in a first longitudinal axial direction to form a first winding layer and, after reaching one longitudinal end of the coil, the wire is wound in the opposite direction, again winding the windings immediately and adjacent to each other. Such winding patterns limit the technical possibilities or alternatively the technical configuration possibilities of the electrical component.

The invention is based on the task of providing an electrical component, in particular an electrical coil body, which is respectively optimized with regard to a simple and fast as well as cost-effective manufacturability and at the same time has a high performance, in particular a compact design and/or a high magnetic density for the windings.

The task is solved by an electrical component, in particular an electrical coil, comprising a plurality of windings of a wire, which are wound or alternatively arranged on a main body defining an axis, in particular a coil axis, according to claim 1. The claims dependent thereupon relate to possible embodiments of the electrical component as well as a method for manufacturing an electrical component and an electrical assembly comprising at least two of the electrical components described herein.

The invention relates to an electrical component, in particular an electrical coil, comprising a plurality of windings of a wire, which windings are wound on a main body or alternatively on a coil main body that defines an axis, in particular a coil axis. The windings are arranged in a plurality of winding layers which are at different spacings to the axis or alternatively to the coil axis, wherein (a) at least one outer, in particular outermost, winding layer is wound, preferably directly, on an inner winding layer laying closer to one of the axes of the main body or alternatively to a center of the main body, and (b) a first winding wound, in particular in direct contact with the main body, and the last winding wound on the main body are arranged on the same side of the main body. The electrical component can, for example, be designed as an electrical coil. In this case, the electrical component or alternatively the electrical coil can be combined with other, in particular similar or identically configured, electrical components or alternatively electrical coils to form an assembly and thus form an assembly of an electric motor. By way of example, this assembly forms a stator and/or a rotor and/or a component of the aforementioned elements of an electric motor.

The winding of the wire around the main body of the electrical component occurs in such a way that the windings are wound on the main body in a plurality of winding layers. A winding layer is to be understood as a layer of windings aligned, in particular, substantially parallel to the axis of the main body or alternatively parallel to the coil axis of the coil main body. The windings do not necessarily need to occur through windings that are immediately wound up directly one after the other or alternatively in contact with each other (laterally or alternatively in the axial direction), but rather can at least partially be “enwrapped” from different winding layers into any other winding layers and there form part of said winding layer or alternatively said winding layer running, in particular, substantially parallel to the axis of the main body.

The wire of the electrical component can, in the intended use, be energized and, at least in the energized state, can be used to generate an electrical magnetic field. In order to achieve a high electrical performance of the electrical component or alternatively the electrical coil, it is advantageous to achieve a high packing density or alternatively an arrangement of the wire or alternatively the windings on the electrical component or alternatively the electrical coil that is as compact as possible.

The present electrical component comprises a first winding wound on the main body, preferably in direct contact with it, wherein the last winding wound on the main body is arranged on the same side of the main body as the first winding. When the first and the last winding of the electrical component are arranged on the same side, this means, for example, that when observing the main body perpendicular to the axis (for example, longitudinal axis) or alternatively to the coil axis, the first and the last winding are respectively arranged at an upper or at a lower end of the axis.

In other words, the main body can define or provide a receiving volume, which is in particular sleeve-like or alternatively tube-like and/or hollow truncated cone-like, for receiving the wire forming the windings, in particular, optionally with the involvement of further elements. When speaking of the same side, this may, for example, mean the arrangement of the first winding and the last winding at the same end portion of the sleeve-like or tube-like receiving volume. Thus, it is possible that the main body is elongated, wherein its longitudinal axis and the coil axis, which is to say, the axis of symmetry of the wound or alternatively coiled windings, are, in particular, substantially coinciding or congruent, and wherein both the first winding and the last winding are arranged at one longitudinal end of the main body.

If the first and the last winding are arranged at the same end of the main body, the wire section leading into the electrical component and leading away from the electrical component is also located at the same end of the main body, such that the interconnection of the electrical component with at least one contiguous further electrical component, in particular with at least one electrical component of similar or identical design, is simplified. In other words, with the arrangement of the first and the last winding of the wire wound on the main body on the same side of the main body or alternatively on the same axial end region of the main body, an advantageous electrical component can be achieved, since a wiring or alternatively the causation of an electrical connection is made possible in a narrowly limited localized region. In particular, if a plurality of electrical components of the similar or identical configuration are interconnected or alternatively wired to one another, especially in series, it is advantageous if the electrical interface is maintained in a narrow or alternatively concentrated in a localized area. In this way, for example, the length of a current-conducting connection section for the connection of at least two electrical components outside the actual receiving volume for the wire can be reduced.

It is possible for the main body to have a base section running, in particular, substantially parallel to the axis of the main body and side sections extending out from the base section substantially perpendicular to the axis, in particular to the coil axis, of the main body, wherein a receiving volume for receiving the windings of the wire is formed by the side sections and the base section. This receiving volume can, for example, form or alternatively define a hollow cylindrical or hollow truncated cone section in which the wire forming the windings is received at least in sections, this wound wire or alternatively the wound windings can form a winding body which has, in particular, a hollow cylindrical or hollow truncated cone shape. In other words, the main body may comprise a cross-sectionally U-shaped and annular groove-like receiving region, wherein the central leg of the U-shape forms the base section. By way of example, as viewed in a longitudinal direction along the axis of the main body, the at least one side section may be arranged or formed, for example, at an end region of the base section. By way of example, a first side section and a further side section may have an equal or different radial length, which is to say, for example, that the maximum extension of the first side section is equal to or different from the maximum extension of the further side section, wherein the extension can be seen as a spacing perpendicular to an outwardly facing surface of the base section. In other words, the maximum extension of the side portions may be present as a radial distance starting from an axis of the main body or alternatively a coil axis of the coil main body.

In an optional further development, it can be expedient if at least one winding delimiting the outer winding layer, in particular the outermost winding layer, has a greater spacing to at least one side section of the main body than at least one inner winding layer delimiting winding of the inner winding layer. This greater spacing of the outer, in particular outermost, winding layer can, for example, be combined with the fact that the axial length of this outer or alternatively outermost winding layer is shorter than the axial length of a winding layer arranged further inside or alternatively closer to the axis of the main body. Preferably, the spacing of the winding delimiting the outer winding layer of this winding layer to at least one side section may be greater than or equal to a diameter of the wire forming this winding layer, more preferably greater than or equal to twice the diameter of the wire forming this winding layer, most preferably greater than or equal to four times the diameter of the wire forming this winding layer. At least the outermost layer can, for example, be incompletely wound and have an unwound or alternatively free and/or axial spacing of a winding arranged in or alternatively assigned to this winding layer and/or delimiting this winding layer to at least one side section. An unwound spacing herein means that no further winding is regularly wound, in particular no further winding is arranged at all in this spacing between a winding of a winding layer to the side section in this winding layer plane. In this sense, a wire or alternatively jump wire that is transferred or arranged in an abrupt manner through the spacing in the area of this winding layer plane does not form a regularly wound winding of this winding layer.

The electrical component may, for example, comprise a first winding of this winding layer delimiting the outer, in particular the outermost, winding layer, which comprises or alternatively defines a first spacing of this winding layer to the first side section of the main body, and a further winding of this winding layer delimiting the outer, in particular the outermost, winding layer, which comprises or alternatively defines a second spacing to the further side section of the main body. Preferably, the first and the second spacing differ by at least the magnitude of the diameter of the wire, preferably by at least the magnitude of twice the diameter of the wire, particularly preferably by at least the magnitude of four times the diameter of the wire. This enables the outer, in particular the outermost winding layer to comprise a free or alternatively unwound spacing to both side sections. This outer, in particular outermost, winding layer can thus be arranged in an axially central region of the winding body formed by the windings.

It should be mentioned that the wire of the electrical component is wound in such a way that (a) in a first step, a first group of windings arranged in the inner winding layer was wound, (b) in a second step, a second group of windings arranged in the outer winding layer was wound, which second group is wound at least in sections, in particular completely, on the first group of windings arranged in the inner winding layer, and (c) in a third step, a third group 24 of windings 5 arranged in a winding layer I, II, III, IV located further inwards relative to the winding layer II, III, IV, V comprising the second group 23 of windings 5, was or alternatively is wound. In so doing, the second group of windings, which at least partially forms an outer winding layer, is supported or alternatively carried, at least in sections, in particular completely, by the first group of windings, which form a section of the inner winding layer.

A group of windings can be defined, for example, as having at least two, preferably at least three, directly successive windings which are wound directly next to each other or alternatively without a spacing between them within a common winding layer. In other words, a group forms a plurality of windings which are wound immediately one after the other, in particular in direct contact with each other. In this manner, it is possible that in each of the groups mentioned in the preceding paragraph, respectively at least two, preferably at least three, particularly preferably at least four, most preferably at least five, are wound directly adjacent to each other and/or in contact with each other. In so doing, the windings of a group are arranged lying in a common winding layer. In other words, a group is formed by winding at least two windings lying directly next to each other in a common winding layer.

In a further advantageous embodiment, the first and the third group of windings may be arranged in the same winding layer or alternatively form part of the same winding layer. By way of example, the common axial length of the first group of windings and of the third group of windings is at least 40%, preferably at least 60%, more preferably at least 80%, most preferably at least 95%, of the axial spacing of the first and of the further side section. In other words, a group of windings is firstly wound in a first winding layer, then a second group of windings is wound in a winding layer different from the first winding layer, and then a third group of windings is wound again in the winding layer in which the first group of windings is also arranged. In this context, the third group of windings can immediately adjoin the second group of windings. It is, however, also possible that after winding the first group of windings, one or more groups of windings are wound as a second group of windings, before the third group of windings is wound. The common axial length of the first and third groups of windings in the same winding layer may, for example, comprise the magnitude or alternatively sum of longitudinal portions of the windings of the first and third groups of windings within the same common winding layer. Alternatively or additionally, the common axial length may form the spacing which is defined by the windings of the first and third groups of windings delimiting the ends. In other words, the latter may mean that starting from a section that is formed by the windings of the first and third group which are lying in the common winding layer, its maximum extension within the same winding layer is defined by two end windings of said first and third group of windings.

Further, it may prove expedient if the first and the third group of windings are arranged in the same winding layer and have a common axial length which corresponds to a maximum of 90%, preferably to a maximum of 70%, particularly preferably to a maximum of 50%, most preferably to a maximum of 30%, of the axial spacing of the first and the further side section. In so doing, the first and the third group of windings can form a part of the common winding layer and a further group of windings can be wound into the same winding layer. Alternatively, the first and the third group of windings can be arranged in the same winding layer and have a common axial length which corresponds to a maximum of 90%, preferably to a maximum of 70%, particularly preferably to a maximum of 50%, most preferably to a maximum of 30%, of the axial spacing of the first and the further side section. Thus, in their winding layer, the first and third group of windings can only form these winding layers in part, so that the remaining winding layer is formed by at least one further group of windings and/or that at least a partial area of this winding layer has no windings and consequently forms a free area.

It is possible that at least one intermediate winding layer is/are formed or alternatively is/are arranged between the inner winding layer and the main body by windings of the wire. Preferably, the inner winding layer is arranged at least in sections, in particular completely, directly on at least one intermediate winding layer. In other words, the inner winding layer may form a winding layer that is arranged relative to the outer, in particular to the outermost, winding layer, wherein this inner winding layer need not form the innermost winding layer, so that relative to this inner winding layer an intermediate winding layer located even further inwards, which is to say, even closer to the axis of the main body, may be arranged. By way of example, the outer winding layer can be arranged or wound directly on the inner winding layer and the inner winding layer can be arranged or wound directly on the intermediate winding layer. Complementarily, it may optionally be provided that the intermediate winding layer is wound directly on the main body without any further intermediate winding layer. By way of example, one or alternatively a plurality of intermediate winding layers may be arranged closer to the axis of the main body or further inside than the inner winding layer carrying the outer or outermost winding layer. It is possible that the at least one intermediate winding layer, in particular all intermediate winding layers, is/are wound at least in sections, preferably predominantly, particularly preferably completely, without interruption, which is to say, without a jump into a further inner or further outer winding layer, and is/are wound back again into the initial winding layer. In other words, at least one intermediate winding layer can be wound starting at one end (in the Y-direction) and leading regularly or alternatively without forming a gap and/or without leading into a further inner or further outer winding layer, wherein this intermediate winding layer is wound up to the opposite end (in the Y-direction) and only then is used in a further outer winding layer to form a further intermediate winding layer or the inner winding layer or alternatively the winding layer carrying the outer winding layer.

In at least one group of windings which are applied directly one after the other in at least one winding layer, at least two windings applied or alternatively wound one after the other can, for example, form a spacing section or alternatively a gap in this winding layer, wherein the spacing section comprises a spacing or alternatively a gap width of at least one diameter of the wire. Preferably, the spacing of the spacing section or alternatively the gap width of the gap can amount or alternatively correspond to at least twice, preferably three times, particularly preferably four times, most preferably five times, the diameter of the wire.

Optionally, the component and/or the winding body formed by the wire can comprise at least two gaps or alternatively two spacing sections, wherein a first gap is placed or alternatively arranged or formed in a first winding layer and a second gap is placed or alternatively arranged or formed in a further winding layer different from the first winding layer. It may also be provided, for example, that between a winding layer having a first gap and a further winding layer having a further gap there is wound at least one winding layer that is intermediate to and located between these winding layers provided with gaps, which (a) has a smaller number of gaps than the first or further winding layer or (b) has no gaps (not a single gap). In this manner, it is possible that a gap is formed in a first winding layer by winding immediately successive windings and that no gap is formed in the winding layer that follows this winding layer or is arranged immediately below it, which is to say, the windings are wound in such a way that they are formed without interruption or alternatively without a spacing between two windings wound immediately one after the other. It is possible that at least one, preferably only one, winding layer without a gap (winding layer that is located in an intermediate position) is arranged or formed between two winding layers, each of which has a gap.

It is possible that the number of winding layers provided with a gap between two winding layers is a number 1+n, wherein n is an even number or 0. In this manner it is possible, for example, that the winding layers are wound with always alternating winding directions (optionally, where needed, with the exception of the filling of any gaps), in which case at least two, preferably the vast majority, particularly preferably all, of the winding layers provided with a gap (optionally, where needed, with the exception of the filling of any gaps) may have been wound in the same winding direction. Alternatively or additionally, at least two, preferably the vast majority, particularly preferably all, of the winding layers provided without a gap may have been wound in the same winding direction. By way of example, at least two, preferably the vast majority, particularly preferably all, of the winding layers having a gap are wound in a first winding direction and at least two, preferably the vast majority, particularly preferably all, of the winding layers having no (single) gap or alternatively spacing section are wound in a winding direction different from the first winding direction or alternatively in a winding direction opposite to the first winding direction. In so doing, this makes it possible to achieve a stable (due to the overlays/crossings) and a wedge-shaped or alternatively cone-shaped or truncated pyramid-shaped structure of the winding body that skips over a plurality of windings, and, at the same time, a high density of the winding body or alternatively a limited number of bulges caused by overlays/crossings. This results in a high-performance, compactly constructed, and stable coil that is to be wound.

Further, it can be provided that at least one winding or precisely one winding is arranged in the spacing section, wherein this winding received in the spacing section is led into the spacing section from a winding layer having a larger or smaller spacing to the axis or alternatively to the coil axis than the winding layer having this spacing section. In other words, at least one winding originating from a winding layer different from the winding layer assigned to the spacing section leads into the spacing section. The winding received in the spacing section of a winding layer may therefore originate from a winding layer closer to or further away from the axis of the winding layer having the spacing section. Thereby, the winding layer leading into the spacing section executes a winding layer-spanning movement, in particular immediately before it is introduced into the spacing section. By way of example, the winding introduced into the spacing section forms a jump winding, which jumps from a winding layer located further inside or further outside into the winding layer having the spacing section. This winding pattern or alternatively the guidance or alternatively winding of the wire executed for this purpose characterizes the electrical component and is also to be understood as a method for manufacturing the electrical component.

Alternatively or additionally, at least one winding or precisely one winding can be arranged in the spacing section, wherein this winding received in the spacing section is led into the spacing section starting from the same winding layer as the winding layer comprising the spacing section. Consequently, in this case, the winding introduced into the spacing section must skip over at least one delimiting winding defining this spacing section. In this case, the winding introduced into the spacing section is briefly guided out of the winding layer comprising the spacing section.

Irrespective of the winding layer from which the winding introduced into the spacing section was previously located, the winding received into the spacing section can span or alternatively skip over at least two, preferably at least three, particularly preferably at least four windings, in particular those arranged in the plane of the spacing section.

The main body may, for example, comprise a base section, in particular running substantially parallel to the axis of the main body, which comprises an elongated cross-sectional basic shape with at least one longitudinal side and one transverse side, wherein the length of the longitudinal side is greater than the length of the transverse side by at least a factor of 1.20, preferably by at least a factor of 1.50, particularly preferably by at least a factor of 2.50, most preferably by at least a factor of 3.50. The basic cross-sectional shape may form, for example, a regular or irregular polygon or an oval having an axis of symmetry or no axis of symmetry. Preferably, the basic cross-sectional shape is rectangular.

At least one transition section of a winding or alternatively jump winding guided from the outer winding layer into the inner winding layer can, for example, be guided at least in sections, in particular exclusively, over a transverse side of the elongated main body. The transition section of the winding or alternatively jump winding, which relates to the winding layer change, can be understood as the section of this winding or alternatively jump winding, which carries out the winding layer change. In other words, the transition section forms the section of the winding that represents the transition or alternatively the jump of the winding from a first winding layer to another winding layer. This transition or alternatively this jump can include a crossing or alternatively a cross-over of windings that are already present in the initial winding layer of the jump winding, and, in particular, that themselves are executing a jump in planes or alternatively even a change of winding layer, so that a winding section led out of this winding layer plane can be formed. This crossing transition section or alternatively this crossing jump winding can also be referred to as an overlay. If the at least one transition section is arranged on the transverse side of the elongated main body, this can be advantageous in that, in the event of a juxtaposition of a plurality of similar or identically formed electrical components on their longitudinal side, the transition section does not lead to an increase in the spacing of the juxtaposed electrical components. The disruptive effect of the radially outward extending and space-consuming transition section can be shifted to the area of the transverse side, so that a compact structure is made possible for the electrical components to be placed together parallel to the longitudinal sides.

Windings crossing over one another or alternatively windings on at least one transverse side and/or on both transverse sides can form cavities, in particular cavities exposed to the outside. Such cavities can be used to receive material surrounding the winding body. By way of example, after winding the wire, the winding body or alternatively the electrical component is provided with a plastic material, in particular by means of injection molding or casting. This plastic material can penetrate into the cavities and cure there. In this way, a form-fit connection component can be achieved in the connection of the plastic material with the electrical component or alternatively with the winding body.

In general, a crossover or transition section can be provided at those locations where an accentuation or alternatively a bulge of the winding body is desired. In the case of enwrapped functional elements, the elevations caused by these can also be compensated for by adapting the crossings or alternatively the transition sections (overlays), for example, next to these functional elements or alternatively at a distance from the functional elements, and the areas can thus be leveled, notwithstanding the enwrapped functional elements.

A transverse side of the electrical component or alternatively a transverse side of the winding body can be understood as the switching side and thus as the side of the component or alternatively the winding body on which switching elements, such as wires and/or actuators and/or sensors, are arranged during intended use. By way of example, the wire feed and/or the wire discharge or alternatively the interfaces for connecting the wire to contiguous electrical components are provided on the switching side of the component or alternatively the winding body.

A first transition section of a winding, guided from an outer winding layer into an inner winding layer can, for example, be guided at least in sections, in particular exclusively, over a first transverse side of an elongated main body, and a second transition section of a winding, guided from an outer winding layer into an inner winding layer or from an inner winding layer into an outer winding layer, can be guided at least in sections, in particular exclusively, over a second transverse side different from the first transverse side and/or a longitudinal side of the elongated main body. Inasmuch as, in the case of at least two transition sections on an electrical component, these transition sections are arranged on different transverse sides, this can positively influence the electrical behavior, with in particular a homogeneous magnetic field structure.

It is possible that one transition section of a winding guided from an outer winding layer into an inner winding layer is guided at least in sections, in particular exclusively, over a first transverse side of an elongated main body, and a second transition section of a winding guided from an outer winding layer into an inner winding layer or from an inner winding layer into an outer winding layer is guided at least in sections, in particular exclusively, over the first transverse side of the elongated main body. Inasmuch as at least two, in particular all, transition sections of a winding of an electrical component are arranged on the same transverse side of the main body, this can promote the achievement of a compact design of the electrical component.

It is possible that the first winding and the last winding of the electrical component, in particular of the winding body, are arranged at the narrow or alternatively narrower end and/or at the end region facing the center (in the final assembled state of the stator) of the component tapering towards one end. In other words, the first and last windings are arranged on the narrow end of the binding body tapering towards one end and/or towards the center of the assembled stator assembly comprising a plurality of electrical components, in particular wedge-shaped electrical components. Inasmuch as, the first and last windings of the electrical component, in particular of the winding body, are arranged on the narrow side of an electrical component which is, in particular, substantially wedge-shaped, this means that these first and last windings can be connected to first and last windings of neighboring electrical components with a short connecting path, for example, by means of a switching ring. This switching ring can thus be smaller (in volume and/or in weight).

In addition to the electrical component, the invention also relates to a method of manufacturing an electrical component described herein, in particular an electrical coil. This method of winding the main body to achieve the winding pattern described above can be based on a defined manufacturing process which can be clearly derived therefrom and which can be predetermined, for example, by the order in which the individual windings are wound.

The invention, moreover, also relates to an electrical assembly, in particular an electric motor, comprising at least one electrical component described herein. The electrical component may hereby, for example, form a component of a stator or alternatively of a rotor. It may prove advantageous if the electrical component has a substantially circular segment-like or pie-piece-like shape, wherein these individual circular segment-like electrical components can be assembled to form a circular ring or alternatively a hollow cylinder-like ring.

All advantages, details, embodiments and/or features of the electrical component according to the invention are transferable or alternatively applicable to the method or alternatively to the manufacturing method and to the electrical assembly.

The invention is explained in more detail with reference to embodiment examples in the drawings. Wherein:

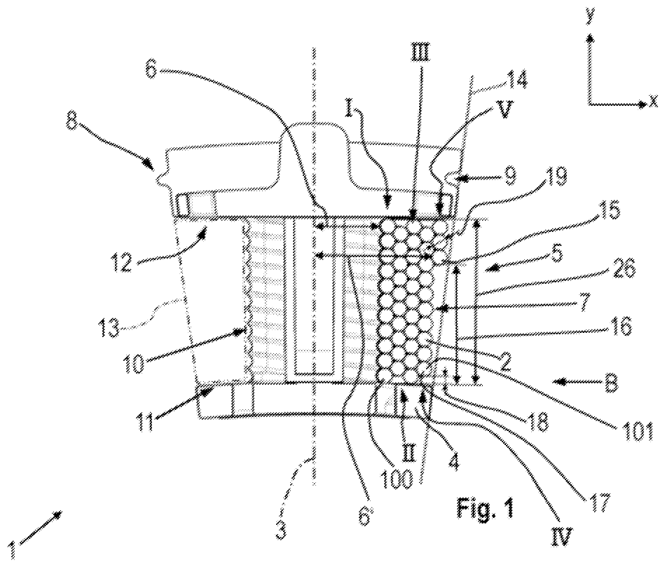

FIG. 1 shows a schematic representation of an electrical component with a main body on which a plurality of windings of a wire are wound according to one embodiment example;

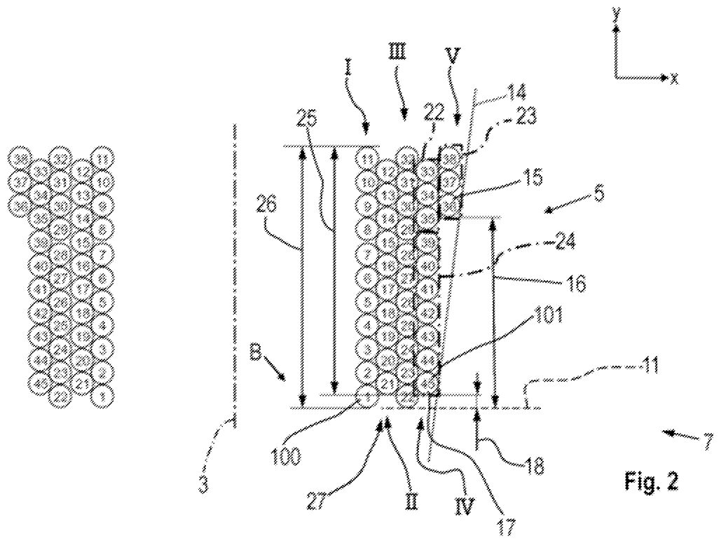

FIG. 2 shows a schematic representation of a winding body of an electrical component comprising a plurality of windings in a cross-sectional view in the Y-X cross-sectional plane according to one embodiment example;

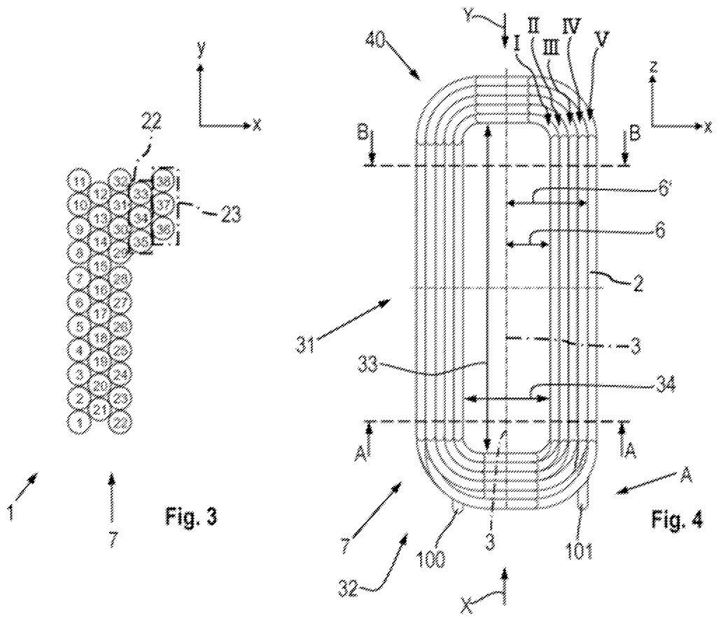

FIG. 3 shows a schematic representation of one half of a winding body comprising multiple windings of an electrical component in a cross-sectional view in the Y-X cross-sectional plane according to one embodiment example;

FIG. 4 shows a schematic representation of a winding body comprising a plurality of windings of an electrical component according to FIG. 2, in the plan view, according to one embodiment example;

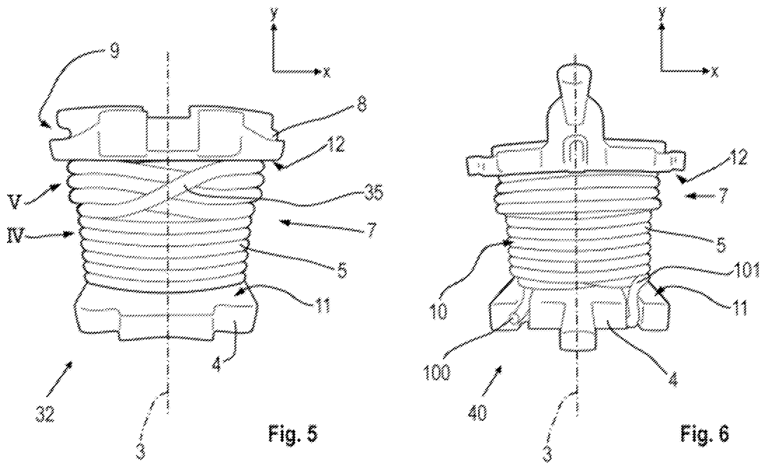

FIG. 5 shows a schematic representation of a side view of a first transverse side of an electrical component according to one embodiment example;

FIG. 6 shows a schematic representation of a side view of a further transverse side of an electrical component according to one embodiment example;

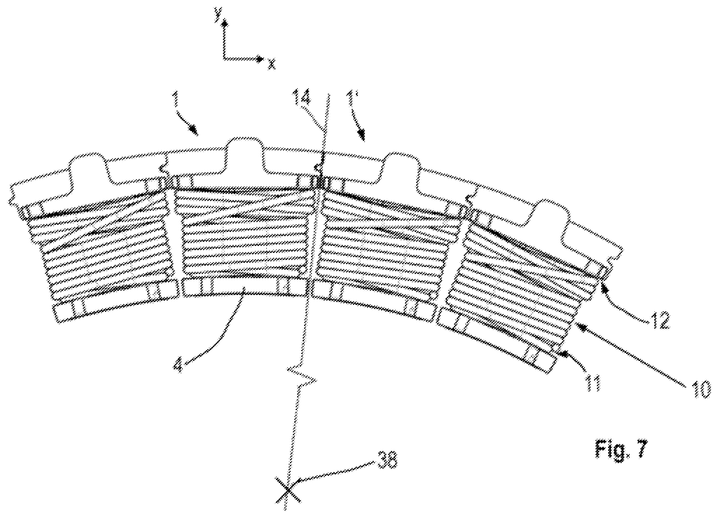

FIG. 7 shows a schematic representation of a section of electrical components of similar or identical design assembled in the final assembly state to form a ring according to one embodiment example;

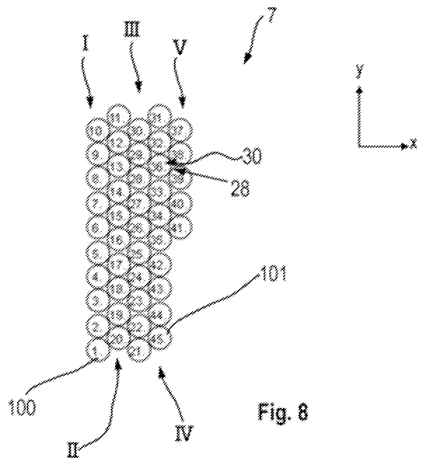

FIG. 8 to FIG. 18 each show a schematic representation of one half of a winding body of an electrical component comprising a plurality of windings, in a cross-sectional view, according to different embodiment examples;

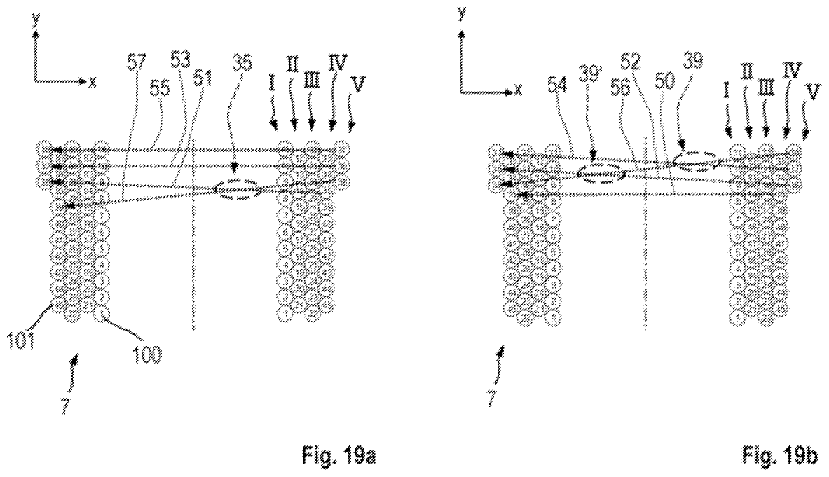

FIG. 19a shows a schematic representation of a winding body comprising multiple windings of an electrical component, in a cross-sectional view, in the Y-X cross-sectional plane, near a first end face according to one embodiment example;

FIG. 19b shows a schematic representation of a winding body comprising multiple windings of an electrical component, in a cross-sectional view, in the Y-X cross-sectional plane, near a further end face according to the embodiment of FIG. 19a;

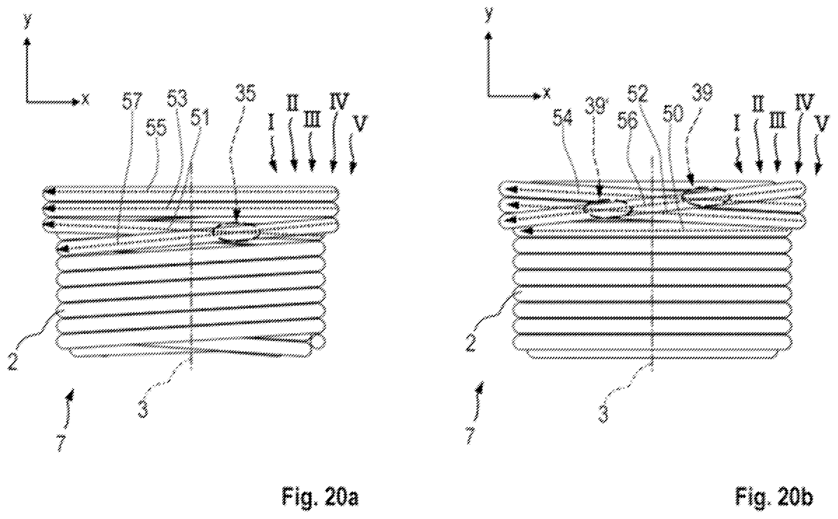

FIG. 20a shows a schematic representation of a side view of a first transverse side of an electrical component according to the embodiment of FIG. 19a;

FIG. 20b shows a schematic representation of a side view of a further transverse side of an electrical component according to the embodiment of FIG. 19a or alternatively 19b;

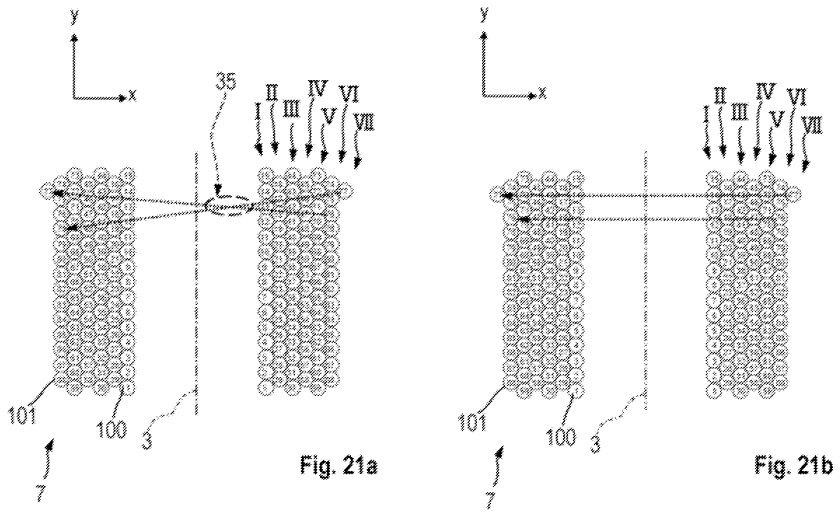

FIG. 21a shows a schematic representation of a winding body of an electrical component comprising a plurality of windings in a cross-sectional view in the Y-X cross-sectional plane near a first end face according to one embodiment;

FIG. 21b shows a schematic representation of a winding body of an electrical component comprising a plurality of windings in a cross-sectional view in the Y-X cross-sectional plane near a further end face according to the embodiment of FIG. 21a;

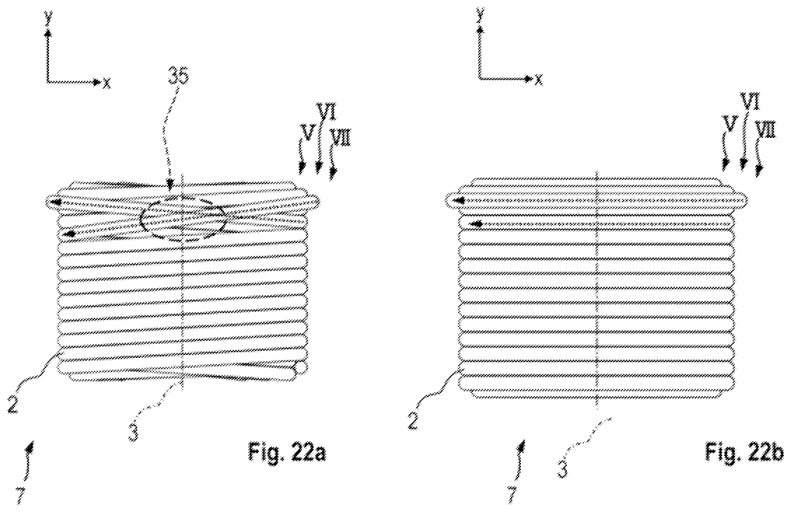

FIG. 22a shows a schematic representation of a side view of a first transverse side of an electrical component according to the embodiment of FIG. 21a;

FIG. 22b shows a schematic representation of a side view of a further transverse side of an electrical component according to the embodiment of FIG. 21a or alternatively FIG. 21b.

FIG. 1 shows an electrical component 1, in particular an electrical coil, comprising a plurality of windings 5, 100, 101 of a wire 2, which are wound on a main body 4 (coil main body) that defines an axis 3, in particular a coil axis, wherein the windings 5 are arranged in a plurality of winding layers I, II, III, IV, V having a different spacing 6, 6′ to the axis 3 (coil axis), wherein (a) at least one outer, in particular outermost, winding layer II, III, IV, V is wound, preferably directly, on an inner winding layer I, II, III, IV closer to the axis 3 of the main body 4, and (b) a first winding 100 which is wound in direct contact with the main body 4 and the last winding 101 wound on the main body 4 are arranged on the same side A, B, D of the main body 4. The wire 2 is shown in FIG. 1 only on one half of the main body 4.

FIG. 1 and FIG. 4 show a first spacing 6 of an innermost winding layer I to the axis 3 and a further spacing 6′ of an outer winding layer II, III, IV, V (here outermost winding layer V) to the axis.

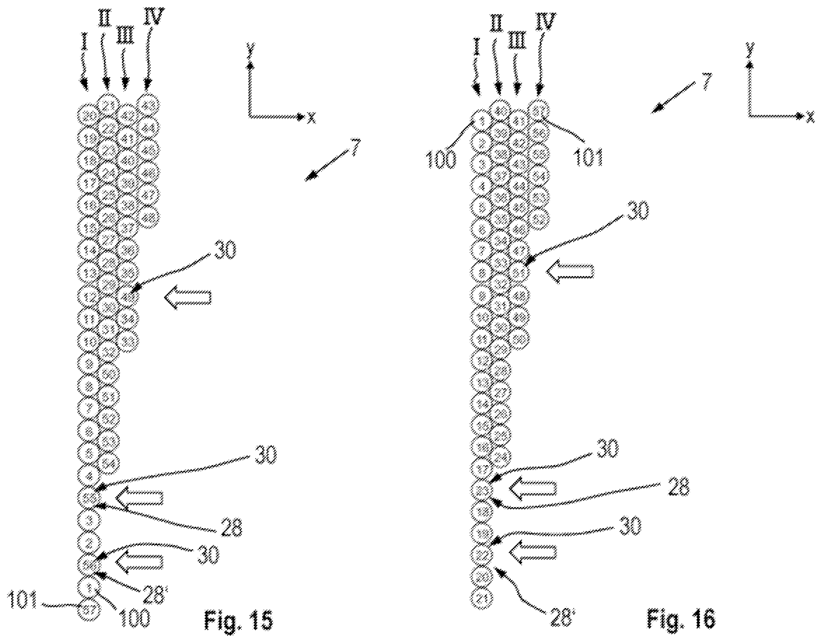

In the embodiments of FIG. 1 through FIG. 14 and FIG. 19a through FIG. 20b, the winding body 7 or alternatively the binding body formed from the windings 100, 101 respectively comprises a total of five winding layers I, II, III, IV, V, wherein the winding layer I forms the innermost winding layer I and winding layer V forms the outermost winding layer V. In the exemplary embodiments of FIG. 15 through FIG. 18, the winding body 7 or alternatively binding body comprises a total of four winding layers I, II, III, IV, wherein the winding layer I forms the innermost winding layer I and the winding layer IV forms the outermost winding layer. In the embodiment according to FIG. 22a through FIG. 23b, the winding body 7 or alternatively the binding body comprises seven winding layers. In the following explanations, reference is made primarily to the 5-layer embodiment. The explanations given below are, however, not limited exclusively to the 5-layer embodiment, but rather are applicable to electrical components 1 with at least two winding layers.

In the reference signs given in the text, reference is made primarily to embodiments with five winding layers I, II, III, IV, V, this is to be understood in such a way that for the case of a winding body 7, with four winding layers, the outermost winding layer is formed with the fourth winding layer IV, in an embodiment with five winding layers, the outermost winding layer forms the fifth winding layer V and in an embodiment with seven winding layers, the outermost winding layer forms the seventh winding layer VII.

As can be seen in FIG. 1, the axis 3 or alternatively the coil axis can form, for example, a vertical axis (cf. Y axis) of the electrical component 1. This axis 3 can, for example, form a vertical axis and/or a rotation axis for the winding of the electrical component 1 with a wire 2 and/or form an axis of symmetry of a main body 4 which is symmetrical at least in sections, in particular completely, as viewed from at least one view.

The main body 4 can, for example, be configured as a body provided with or without a metallic component/metallic components, on which the at least one wire 2 forming the multiple windings or alternatively the winding body 7 is wound. The main body 4 can, for example, form a carrier body for the wire 2 forming the multiple windings or alternatively the winding body 7. It may be expedient if the main body 4 comprises an engagement element 8 and/or a mating element 9. In the embodiment shown in FIG. 1, the main body 4 comprises an engagement element 8 formed as a highlight and a mating element 9 formed as a recess.

The engagement and/or mating element 8, 9 can be set up so that, in the final assembly state, the engagement and/or mating element 8, 9 of a first main body 4 of a first component 1 engages with a corresponding counter and/or engagement element of a component 1′ neighboring the first component 1 or alternatively connects with one another at least in a force-fitting and/or form-fitting manner, cf. FIG. 7. The engagement and/or mating element 8, 9 can be provided with at least one guide section which performs a centering and/or a guiding function during the bringing together of the connection partners (engagement and mating element 8, 9) of two electrical components 1, 1′.

It is possible for the main body 4 to comprise a base section 10 extending, in particular, substantially parallel to the axis 3 or alternatively to the coil axis of the main body 4 and side sections 11, 12 extending from the base section 10 substantially perpendicular to the axis 3 or alternatively to the coil axis of the main body 4, wherein a receiving volume 13 for receiving the windings 5, 100, 101 or alternatively of the winding body 7 of the wire 2 is formed by the side sections 11, 12 and the base section 10. For ease of reading, the winding body 7 and the side section 11, 12, for the left half of the main body 4, are predominantly represented or alternatively drawn in the following figures. The windings 5, 100, 101 are shown on both sides of the main body 4 in FIG. 2; in the further figures, the windings 5, 100, 101 or alternatively the winding body 7 are shown predominantly, by way of example, respectively only for one half, cf, for example, FIG. 1 and FIG. 3.

As shown in FIG. 1, the receiving volume 13 can be arranged in a recess of the main body 4 in the form of an annular groove. In this case, a cross-sectional contour shape (contour shape in the X-Z cross-sectional plane) of the annular groove can have any shape, for example, it can be at least in sections, in particular completely round and/or angular. In other words, the main body 4, in the region of its base section 10, may have, for example, a triangular or square or pentagonal or n-sided cross-sectional contour shape (which is to say, in a cross-section in the X-Z plane). Alternatively or additionally, the cross-sectional contour shape of the base section 10 may be rectangular and/or square. The annular groove-like shape has a base section 10 running, for example, along and/or parallel to the axis 3 or alternatively the vertical axis. The base section 10 can form a U-shape with the side sections 11, 12 extending away from it, in particular, directed radially outwards from the axis 3, wherein the free legs of the U-shape are formed by the side sections 11, 12 and the section of the U-shape connecting the free U-legs being formed by the base section 10. The base section 10 can have, at least in sections, in particular completely, a rectilinear shape and/or—as shown in FIG. 1—a corrugated shape and/or a shape corresponding to the winding body 7 to be received, on its surface facing the receiving volume 13. By way of example, the surface of the base section 10 is provided at least in sections, in particular completely, with a helically running, preferably rounded, groove, in which the wire of the winding body 7 is received at least predominantly in a flat adjacent manner.

FIG. 1, FIG. 3, and FIG. 8 through FIG. 18 respectively show only one half of the windings 5 or alternatively of the winding body 7 of an electrical component 1.

Moreover, it is evident from FIG. 1 that the winding body 7 or alternatively the windings 5 of an electrical component 1 form a shape or alternatively geometry in the manner of a hollow truncated cone. The side section 11 facing the center 38 in the final assembly state of an annular arrangement of a plurality of components 1, 1′ can also be shorter in its radial extent than the side section 12 arranged further away from the center 38. In other words, the electrical component 1 can have a shape in the manner of a cone. For this purpose, it may be provided that the windings 5 of the winding body 7 form a tiered or alternatively a stepped shape. By such an oblique pathway of an outer boundary line 14, a compact and/or a high density of the wire 2 can be achieved in an annular arrangement of a plurality of electrical components 1, 1′ formed in this way, cf. FIG. 7.

It is possible that at least one winding 15 delimiting the outer, in particular the outermost, winding layer II, III, IV, V of the outer, in particular the outermost, winding layer II, III, IV, V has a greater spacing 16 to at least one side section 11, 12 of the main body 4 than one inner winding layer I, II, III, IV delimiting at least one winding 17 of the inner winding layer I, II, III, IV, with its spacing 18, cf. FIG. 2. Preferably, the spacing 16 of the winding 15 delimiting the outer winding layer II, III, IV, V of this winding layer II, III, IV, V to at least one side section 11, 12 can be greater than or alternatively equal to a diameter 19 of the wire 2 forming this winding layer II, III, IV, V, particularly preferably greater than or equal to twice the diameter 19 of the wire 2 forming this winding layer II, III, IV, V, most preferably greater than or equal to four times the diameter 19 of the wire 2 forming this winding layer II, III, IV, V. Inasmuch as the outer winding layer II, III, IV, V has a greater spacing 16 to a lateral surface 11, 12 than a winding layer I, II, III, IV lying further inwards to the same lateral surface 11, 12, a conical or alternatively a hollow truncated cone-like or hollow truncated pyramid-like shape of the windings 5 or alternatively of the winding body 7 is achieved.

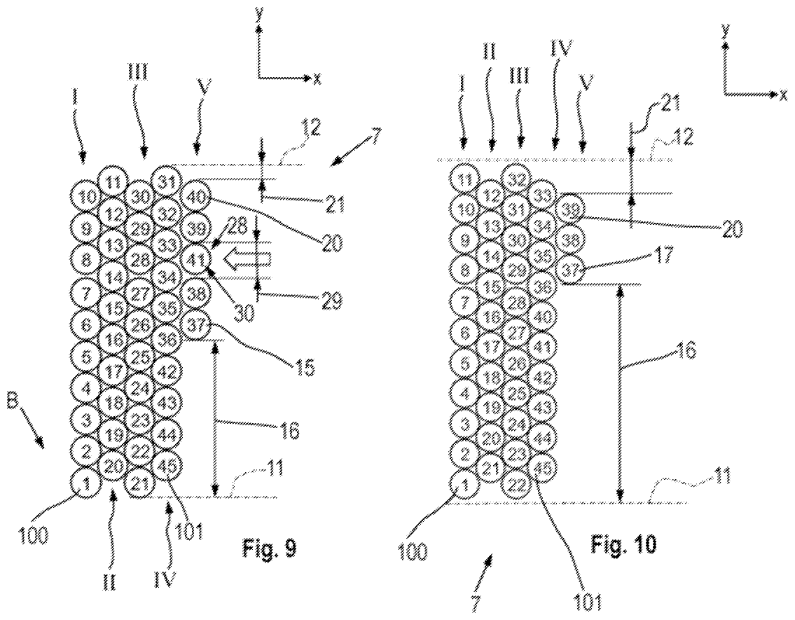

A first winding 15 of this winding layer II, III, IV, V delimiting the outer, in particular the outermost, winding layer II, III, IV, V can, for example, comprise a first spacing 16 to the first side section 11 of the main body 4 and a further winding 20 of this winding layer II, III, IV, V, delimiting the outer, in particular the outermost, winding layer II, III, IV, V can comprise a second spacing 21 to the further side section 12 of the main body 4. Preferably, the first and the second spacings 16, 21 may differ by at least the (single) magnitude of the diameter 19 of the wire 2, preferably by at least the magnitude of twice the diameter 19 of the wire 2, particularly preferably by at least the magnitude of four times the diameter 19 of the wire 2. Alternatively or additionally, the length of the spacings 16, 21 may differ by at least a factor of three, preferably by at least a factor of five, particularly preferably by at least a factor of 7.5, most preferably by at least a factor of 9.5. In the embodiment shown in FIG. 9, the spacing 21 is half the wire diameter 19 and the spacing 16 is five times the wire diameter 19, resulting in a factor of ten difference of the spacings 16, 21.

The diameter 19 or alternatively the thickness of the wire 2 can be, for example, between 0.5 and 4.0 mm, preferably between 1.0 and 2.5 mm, particularly preferably between 1.1 and 1.9 mm, most preferably between 1.3 and 1.7 mm. The diameter 19 of the wire 2 can be at least predominantly, in particular completely, constant. Here, a constant diameter 19 of the wire 2 means that it has a diameter variation of at most 15%, preferably at most 10%, particularly preferably at most 6.5%, most preferably at most 2.5%.

It is possible that the wire 2 is wound on the main body 4 in such a way that (a) in a first step, a first group 22 of windings 5 arranged in the inner winding layer I, II, III, IV has been wound, (b) in a second step, a second group 23 of windings 5 arranged in the outer winding layer II, III, IV, V has been wound, which has been or alternatively will be wound at least in sections, in particular completely, on the first group 22 of windings 5 arranged in the inner winding layer I, II, III, IV, and (c) in a third step, a third group 24 of windings 5 arranged in a winding layer I, II, III, IV, located further inwards relative to the winding layer II, III, IV, V comprising the second group 23 of windings 5, was or alternatively is wound. This can be seen, for example, from FIG. 2 and FIG. 3. In FIG. 2, a first group 22 of windings 5 (with the numbers 33, 34 and 35) was first wound in winding layer IV, followed by the winding of the windings 5 (with the numbers 36, 37 and 38) which form the second group 23 of windings 5, which are arranged in a further radially outwardly directed winding layer V, here optionally in the outermost winding layer V, or alternatively which form this winding layer V at least partially, in particular completely (as shown). An intermediate state of the winding according to FIG. 3 is thus achieved. After the second group 23 of windings 5 has been wound, the wire 19 subsequently jumps back with the winding 5 (with the number 39) into the previous winding layer IV or alternatively into the winding layer IV comprising the first group 22 of windings 5 and there forms the remainder of this winding layer IV with the windings 5 (numbers 40 through 45). The numerical data specified as numbers and given in brackets indicate the winding sequence; these are always to be regarded as exemplary data, which is to say, the respective embodiment examples elucidated with numerical data can also relate to any other numerical data or alternatively to a different sequence of the corresponding winding 5. By way of example, the winding 5 with the number 1 is the first winding 5, 101 of wire 2, followed by the winding 5 with the number 2, and so on. In the example of FIG. 2, the winding or alternatively winding body 7 comprises a total of 45 windings 5, wherein the winding 5 with the number 45 is the last winding 5, 101 of the winding body 7.

In an optional further development, it can be provided that the first and the third group 22, 24 of windings 5 are arranged in the same winding layer I, II, III, IV, cf. FIG. 2 and FIG. 3. Preferably, a common axial length 25 (in Y-direction) is at least 40%, particularly preferably at least 60%, most preferably at least 80%, of the axial spacing 26 of the first and the further side section 11, 12. Here, the (total) length 25 in Y-direction made up from the respective length sections of the first and third groups 22, 24 is considered. The length running parallel to axis 3 or alternatively a corresponding projection onto this axis 3 of the lengths 25 of the first and third groups 22, 24 and of the axial spacing 26 of the side sections 11, 12 can here be considered.

The first and the third group 22, 24 of windings 5 can, for example, be arranged in the same winding layer I, II, III, IV and have a common axial length 25 which corresponds to a maximum of 90%, preferably to a maximum of 70%, particularly preferably to a maximum of 50%, most preferably to a maximum of 30%, of the axial spacing 26 of the first and the further side section 11, 12.

Between the inner winding layer II, III, IV and the main body 4, at least one intermediate winding layer 27 can, for example, be formed by windings 5 of the wire 2. The intermediate winding layer thus forms a winding layer or alternatively intermediate winding layer 27 (for example, winding layer I) arranged further inwards or alternatively closer to the axis 3 relative to the inner winding layer II, III, IV; this is shown by way of example in FIG. 2 as first winding layer I, which also comprises the first winding 101. The intermediate winding layer 27 can also be a winding layer II, III, IV, different from the winding layer I, comprising the first winding 101. Preferably, the inner winding layer II, III, IV is, at least in sections, in particular completely arranged or alternatively wound directly on at least one intermediate winding layer 27.

For example, it may prove expedient if a regular winding pattern is initially executed at the beginning of the winding process, which is to say, for example, that the winding pattern during the winding of a defined winding layer I, II, Ill (cf. FIG. 2) within the winding process along the axis 3 or alternatively the Y axis does not provide any spacing sections 28, 28′ and/or any jumps into a winding layer lying further inside or further outside, but only jumps into a winding layer lying further outside or further inside after reaching the end (for example, the side section 11, 12) and/or after winding of the winding 5 defining the end of this winding layer. This is shown, by way of example, in the embodiment of FIG. 2, where the intermediate winding layers 27 (here: winding layers I, II, III) are wound without interruptions (without spacing sections) and without jumps in the axial central region (along the Y axis) into a winding layer lying further inside or further outside. Only the outer winding layer (here: winding layer IV) has a jump to the outermost, fifth winding layer V in a non-end region or alternatively in an axial central area with the winding 5 having the number 35 and then later a jump back to the fourth winding layer IV. Inasmuch as the intermediate winding layers 27 lying further inwards are initially wound in the regular manner and the geometry that is responsible for the higher-performance geometry takes place at the inner winding layer (here: winding layer IV) lying further outwards relative to the intermediate winding layer 27 and at the outermost winding layer (here: winding layer V), efficient and economical production of the component 1 can be achieved.

By way of example, in at least one group 22, 23, 24 of immediately successively applied windings 5 of at least one winding layer I, II, III, IV, V, at least two successively applied or alternatively wound windings 5 may form a spacing section 28 or alternatively a gap in said winding layer I, II, III, IV, V, wherein said spacing section 28 comprises a spacing 29 or alternatively said gap comprises a gap width of at least one diameter 19 of the wire 2. In other words, during the winding of a plurality of windings 5 one after the other within a winding layer I, II, III, IV, V, a gap or alternatively spacing section 28 is formed, wherein said gap or alternatively spacing section 28 occurs by means of a first and a successive winding 5 immediately following the first or alternatively winding of the wire 2 in the winding layer I, II, III, IV, V, cf. FIG. 9.

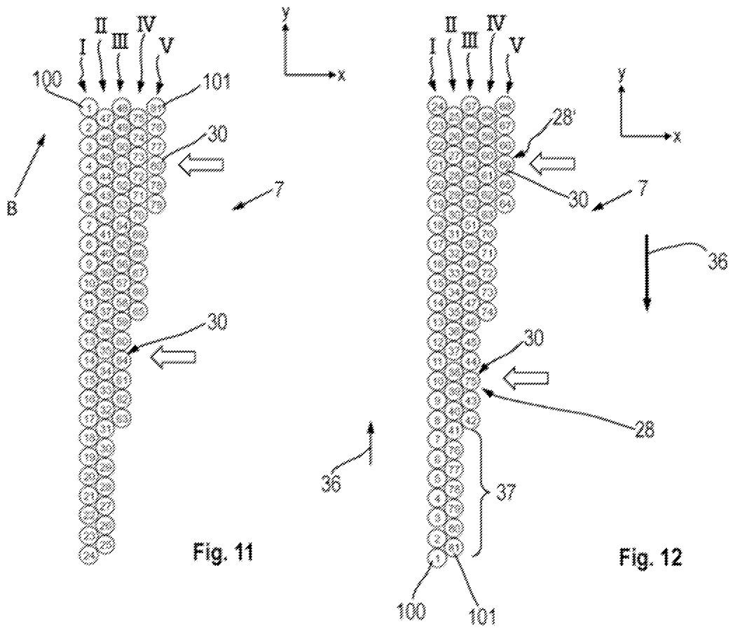

In an optional further development, it may be provided that at least one winding 5 (for example, filling winding 30) or precisely one winding 5 (filling winding 30) is arranged in the spacing section 28 or alternatively the gap, wherein this winding 5 or alternatively filling winding 30 received in the spacing section 28 is led into the spacing section 28 from a winding layer I, II, III, IV, V that is more or less spaced apart to the axis 3 than the winding layer I, II, III, IV, V having this spacing section 28. As can be seen, for example, in the embodiment shown in FIG. 12, in the third winding layer III, the spacing section 28 formed by the windings 5 with the numbers 43 and 44 is filled by a winding 5 or alternatively by the filling winding 30, wherein this filling winding 30 with the number 75 originates from the fourth winding layer IV, which is located further out, or alternatively is taken up or alternatively led into from there by the winding 5 with the number 74 into the spacing section 28 located in the third winding layer III. In the process, the wire 2 with its transfer section from winding 5 with the number 74 through 75 skips over or alternatively crosses or bridges the windings 5 with the numbers 44 through 46.

As can be seen in the embodiment of FIG. 12, it can be alternatively or additionally provided that in at least one spacing section 28′ of the electrical component 1 at least one winding 5 or precisely one winding 5 (for example, having the number 69) is arranged, wherein this winding 5 received in the spacing section 28′ with for example the number 69 is led into the spacing section 28′ starting from the same winding layer V as the winding layer V encompasses the spacing section 28′. In other words, this embodiment, by way of example, comprises at its outermost winding layer V, a spacing section 28′ formed by the windings 5 having, for example, the numbers 65 and 66, wherein the winding 5 is guided into this gap or alternatively into the spacing section 28′ starting from the winding number 68 via the number 69. In this case, the winding 5 bridges or alternatively crosses the windings 5 with the numbers 66 and 67 with its joining section from the number 68 to the 69. In the embodiment example according to FIG. 12, the winding body 7 comprises two spacing sections 28, 28′ or alternatively gaps arranged in different winding layers III, V. The winding body 7 can likewise comprise two or more spacing sections 28 or alternatively gaps within the same winding layer I, II, III, IV, V. Alternatively or additionally, it may be provided that all spacing sections 28, 28′ are filled with filling windings 30, 30′ that respectively originate exclusively from the same or respectively exclusively from one different winding layer I, II, III, IV, V, such as the winding layer I, II, III, IV, V, comprising the spacing section 28, 28′. In other words, it may be provided, for example, that the winding preceding the filling winding 30, 30′ is arranged in the same winding layer I, II, III, IV, V as the winding layer I, II, III, IV, V comprising the spacing section 28, 28′.

It is optionally possible that between two winding layers I, II, III, IV, V provided with a spacing section 28, 28′, at least one, preferably precisely one, winding layer I, II, III, IV, V is arranged or formed which has no spacing section 28, 28′.

In the embodiment in FIG. 11, the outermost winding layer V and the third-outermost winding layer III each comprise, for example, a gap or alternatively a spacing section 28, 28′, wherein the second-outermost winding layer IV, which is located between these winding layers III and V, does not comprise a spacing section 28, 28′ or alternatively a gap. It is likewise apparent from the numbers indicating the sequence of winding that the winding direction 16 for forming the winding layers III and V having the gaps or alternatively spacing sections 28, 28′ is identical, namely is directed in each case from bottom to top or alternatively from the end associated with the center 38 to the end of the winding body 7 facing away from the center 38. It can likewise be seen in the embodiment shown in FIG. 11 that the winding layer IV located between the winding layers III and V provided with gaps can be wound in a winding direction 16 relative to the winding layers III, V provided with gaps. This also applies, for example, to the embodiment shown in FIG. 12.

According to the embodiment, for example, shown in FIG. 15 and FIG. 16, the winding direction 16 of all winding layers I and III provided with gaps or alternatively with spacing sections 28, 28′ is identical. Optionally, the winding direction of all winding layers I and III provided with gaps or alternatively with spacing sections 28, 28′ is different from the winding direction 16 of all winding layers II and V having no (single) gap or alternatively spacing section 28, 28′.

In an optional embodiment, it can be provided, for example, that the at least one winding 5 or alternatively filling winding 30, 30′ received in the spacing section 28, 28′ overlaps or alternatively crosses at least two, preferably at least three, particularly preferably at least four, windings 5.

The main body 4 can, for example, comprise a base section 10, in particular running substantially parallel to the axis 3 of the main body 4, which base section comprises an elongated cross-sectional basic shape as seen in the X-Z plane with at least one longitudinal side 31 or alternatively one long side and one transverse side 32 or alternatively one short side, wherein the length 33 of the longitudinal side 31 is greater than the length 34 of the transverse side 32 by at least a factor of 1.20, preferably by at least a factor of 1.50, particularly preferably by at least a factor of 2.50, most preferably by at least a factor of 3.50, cf. FIG. 4. In FIG. 4, the winding or alternatively the winding body 7 formed from the wire 2 is shown in the plan view according to FIG. 1 or alternatively in the plan view of a section lying in the Z-X plane. Here, the ratio of the length 33 of the longitudinal side 31 to the length 34 of the transverse side 32 is recognizable. It can, moreover, be seen from FIG. 4 that the first winding 100 and the last winding 101 of the electrical component 1 are arranged on the same side, see arrow A. In other words, the input section of the wire 2 or alternatively the wire section forming the first winding 100 is introduced from a first transverse side 32 and on the same transverse side 32 the wire section forming the last winding 101 is led out of the electrical component 1. In the embodiment according to FIG. 4, the first and the last winding 100, 101 wound on the main body 4 are consequently arranged on the same side, in particular in the same area in the Z direction, see arrow A.

According to the embodiment of FIG. 1 and FIG. 2, the first winding 100 (see winding number 1) wound on the main body 4, in particular in direct contact with the main body 4, and the last winding 101 (see winding number 45) wound on the main body 4 may, for example, be arranged on the same side of the main body 4 as regards its height or alternatively as regards its extension in the Y-direction, cf. arrow B.

Alternatively or additionally, the first winding 100 wound on the main body 4, in particular in direct contact with the main body 4, and the last winding 101 wound on the main body 4 may be arranged on the same side of the main body 4 or its extension in the X direction (not shown). By way of example, the wire 2, in the form of the first winding 100, meets the main body 4 at a first angle between the longitudinal and the transverse sides 31, 32, and, in the form of the last winding 101, departs from the main body 4 at a point of the same area in the X-extension of the main body 4.

It is possible that the first winding 100 wound on the main body 4, in particular in direct contact with the main body 4, and the last winding 101 wound on the main body 4 are arranged on the same side of the main body 4 as regards the extension of the main body in X and Y direction and/or in X and Z direction and/or in Y and Z direction. In other words, the sides of the first and last windings 100, 101 coincide with respect to at least two spatial extensions (X, Y, Z), see, for example, the embodiment according to FIG. 6 where the first and last winding 100, 101 are arranged at the same transverse side 32 and at the end pointing to the center 38 and thus to an end region of the main body 4 in Y-direction and to an end region of the main body 4 in Z-direction, cf. arrows A and B. In other words, the first and last winding 100, 101 are arranged at the same end in Y-direction and at the same end in Z-direction.

At least one transition section 35 of a winding 5 guided from the outer winding layer II, III, IV, V into the inner winding layer I, II, III, IV can, for example, be guided at least in sections, in particular exclusively, over a transverse side 32 of the elongated main body 4. As can be seen, in particular, from FIG. 5, a winding 5 which overlaps or alternatively crosses over other windings 5 or alternatively a jump winding—also referred to as overlay winding—is wound on the main body 4 in such a way that the transition section 35 of this winding 5 for the transition from the outer winding layer into the further inner winding layer takes place exclusively on a transverse side 32 or alternatively exclusively in the region of a transverse side 32. In this way, the homogeneous or alternatively rectified alignment of the windings 5 at the longitudinal sides 31 is not impaired, and in particular the homogeneity and/or the eagerness to achieve the highest possible density is not impaired or alternatively disturbed. The eagerness to achieve the smallest possible packing size at the longitudinal sides 31 can moreover be achieved.

A first transition section 35 of a winding 5 guided from an outer winding layer II, III, IV, V into an inner winding layer I, II, III, IV can, for example, be guided at least in sections, in particular exclusively, over a first transverse side 32 of an elongated main body 4, and a second transition section 39 of a winding 5 guided from an outer winding layer II, III, IV, V into an inner winding layer I, II, III, IV or from an inner winding layer I, II, III, IV into an outer winding layer II, III, IV, V can be guided at least in sections, in particular exclusively, over a second transverse side 40, which is different from the first transverse side 32, and/or a longitudinal side 31 of the elongated main body 4. In other words, the electrical component 1 or alternatively the winding body 7 of the electrical component 1 may have at least two transition sections 35, wherein these transition sections 35 are arranged, for example, in particular exclusively, on different transverse sides 32, 40, of the base section 10, cf. FIG. 19a through FIG. 20b.

The position of the schematic diagrams of FIG. 19a through FIG. 20b is represented on the basis of FIG. 4. FIG. 19a and FIG. 19b respectively show a cross-sectional view lying in a Y-X cross-sectional plane, wherein FIG. 19a shows section A-A according to FIG. 4 and FIG. 19b shows section B-B according to FIG. 4. The windings 5 are assigned a number corresponding to the winding sequence. The winding pathway at the transverse sides 32, near a first transverse side 32, 40 is shown in FIG. 19a and FIG. 19b as dotted arrows respectively representing the winding pathway 50, 51, 52, 53, 54, 55, 56, 57, 58, wherein the winding pathway is outside the cross-sectional planes or alternatively highlighted from the respective drawing plane.

Thus the pathway is to be understood in such a way that the winding 5 with the number 35 (right side) in FIG. 19b is led to the winding 5 with the number 35 (left side) in FIG. 19b over the second transverse side 40 with the winding pathway 50. The winding with the number 35 on the left side of FIG. 19b corresponds to the winding with the number 35 on the right side of FIG. 19a, since the viewing direction on the respective sections changes between FIG. 19a and FIG. 19b, cf. FIG. 4. This winding 5 with the number 35 on the right side of FIG. 19a, which is in the fourth layer IV, is brought in the area of the first transverse side 32 into the fifth layer V as the first winding 5, cf winding pathway 51, and then forms the first winding 5 with the number 36 on the left side of FIG. 19a. This winding 5 with the number 36 on the left side corresponds to the winding with the number 36 on the right side of FIG. 19b. The further numbering of the windings 5 and the ascending number of the reference signs of the winding pathways 50, 51, 52, 53, 54, 55, 56, 57, 58 indicate the order in which the wire is wound.

In this way, the winding 5 with the number 35 lying in the fourth layer IV is wound over the first transverse side 32 into the fifth layer V (left side of the figure), thereby forming a first transition section 35. The transition or alternatively this jump in layer, which is to say, the pathway of the change from the fourth to the fifth layer IV, V preferably takes place exclusively in the area of the first transverse side 32, cf winding pathway 51 in the figure.

FIG. 20a shows an external view of the first transverse side 32, cf. arrow X in FIG. 4, and FIG. 20b shows an external view of the second transverse side 40, cf. arrow Y in FIG. 4. Here, the winding pathways 51 through 58 on the transverse sides 32 or alternatively 40 can be seen.

It can be seen that transition sections 35, 39 or alternatively crossing areas or also overlays can occur at the transverse sides 32, 40. Wherein windings wound over are arranged at least in sections, in particular completely, in the same winding layer (which is to say, that on at least one longitudinal side 31 this winding wound over is arranged in the same winding layer as the winding doing the winding over) as the windings winding over (with reference to the position or alternatively location of these windings along the longitudinal sides 31).

According to the version shown in FIG. 19a, the winding pathway 57 winds over the winding pathway 51 generated earlier in the area of the first transverse side 32. This crossing point or alternatively this first transition section 35 and the resulting increased extension in the Z-direction of the winding body 7 is present exclusively at the first transverse side 32. The transition section 39 or alternatively crossing point of the winding pathway 56 winding over shown in FIG. 19b winds over the winding pathways 52 and 54. The elevations in the Z-direction generated from this transition section 39 or alternatively these crossings have an effect exclusively on the geometry of the winding body 7 in the region of the second transverse side 40. This is also evident from FIG. 20a and FIG. 20b.

It is possible that the winding pathways at the transverse sides 32, 40 in a first winding layer enclose a first angle, in particular a right angle, to the axis 3 and a winding pathway at the same transverse side of a winding layer different from the first winding layer, in particular a winding layer immediately contiguous to the first winding layer, encloses an angle different from the first angle. In this respect, it may be provided, for example, that at the two transverse sides 32, 30 the angles of the predominant number of winding pathways with axis 3 are different for at least one defined winding layer. Preferably, the angle of the predominant number of the winding pathways with the axis 3 can be different for at least two winding layers in comparison of two transverse sides 32, 40. By way of example, the winding pathway 50 of the fourth or alternatively second outermost winding layer V in FIG. 20b extends at a right angle to axis 3, whereas on the other hand in FIG. 20a the winding pathway of the fourth or alternatively second outermost winding layer IV includes an angle that is not equal to 90° or alternatively an acute angle (here: approx.) 4°. For the fifth winding layer V, for example, the reverse can be the case, the windings 53, 55 of the fifth or alternatively outermost winding layer V in the region of the first transverse side 32 therefore extend at right angles to axis 3 and the windings 52, 54, 56 of the fifth or alternatively outermost winding layer V in the region of the second transverse side 40 are arranged at an angle not equal to 90° or alternatively at an acute angle (here: for example, 4°).

In this context, the embodiment according to FIG. 21a through FIG. 22b, on a first transverse side 32 (cf. FIG. 22a) for at least two winding layers I, II, IV, V, VI, VII, preferably for all winding layers I, II, IV, V, VI, VII, comprises a winding pathway on the first transverse side 32 which always forms an angle not equal to 90° with the axis 3. On the second transverse side 40, the winding pathways of at least two winding layers, in particular of all winding layers, are aligned at a right angle to axis 3.

The embodiment shown in FIG. 21a through FIG. 22b comprises transition sections 35, 39 exclusively on one transverse side (here on the first transverse side 32), cf. FIG. 22a. There are no transition sections 35, 39 or alternatively crossings on the transverse side 40 opposite the first transverse side 32, cf. FIG. 22b. Thus, in the embodiment of FIG. 21a through FIG. 22b, the winding body 7 builds up more in the Z direction on the first transverse side 32 than on the second, opposite transverse side 40.

On the other hand, in the embodiment shown in FIG. 19a through FIG. 20b, transition sections 35, 39 or alternatively overlays are arranged on both transverse sides 32, 40, as a result the increased buildup in the Z direction resulting from the transition sections 35, 39 can have a more centered or alternatively uniform effect on both transverse sides 32, 40. Depending on the available installation space about the component 1 or alternatively about the winding body 7, the transition section 35, 39 or alternatively the intersections can be implemented on a first or on a second transverse side 32, 40 or distributed on both transverse sides 32, 40. In other words, the winding head height, which is to say, the extension of the winding body 7 in the Z direction, can be adapted to a given installation spacing.

It is possible that a first transition section 35 of a winding 5, guided from an outer winding layer II, III, IV, V into an inner winding layer I, II, III, IV, is guided at least in sections, in particular exclusively, over a first transverse side 32 of an elongated main body 4 and a second transition section 35 of a winding 5, guided from an outer winding layer II, III, IV, V into an inner winding layer I, II, III, IV or from an inner winding layer I, II, III, IV into an outer winding layer II, III, IV, V is guided at least in sections, in particular exclusively, over the first transverse side 32 of the elongated main body 4. In this embodiment, by way of example, at least two, preferably all, transition sections 35 or alternatively jump windings can have at least their predominant, in particular their exclusive, pathway in the region of a single or alternatively the same transverse side 32, 40.

The invention further relates to methods for manufacturing an electrical component 1 described herein, in particular an electrical coil. In particular, the electrical component 1 described herein can be used in an electric motor, preferably for a, in particular drive system, of a vehicle, for example a motor vehicle.

The invention further relates to an electrical assembly, in particular an electric motor, comprising at least one electrical component 1 described herein. FIG. 7 shows a section of electrical components 1 arranged in a ring shape. Herein, the electrical components 1 can be placed against each other at their boundary lines 14 and form a closed ring or alternatively ring composite in the final assembly state. In principle, it is desirable to achieve the smallest possible gap dimensions or alternatively the highest possible density of the magnetically active material and/or the highest possible density of wire 2.

The embodiment according to FIG. 9 comprises an electrical component 1 with five winding layers I, II, III, IV, V, wherein the layers I through IV are wound up and unwound alternately in the Y direction. In the outermost winding layer V, a spacing section 28 or alternatively a gap is formed. An incomplete winding in winding layer IV first occurs by winding the windings 5 with the numbers 31 through 36, thereinafter the outermost winding layer V is wound, which comprises the windings 5 with the numbers 37 through 41, wherein a spacing section 28 is formed in this winding layer V by the windings 5 with the numbers 38 and 39. This spacing section 28 or alternatively gap is filled by guiding the winding 5 (number 41) originating from the same winding layer V or alternatively filling winding 30. Immediately thereinafter, after forming the filling winding 30, the wire 2 is led back via the windings 5 with the numbers 37 and 38 into the fourth winding layer IV and thereby connects to the winding 5 with the number 36 temporarily delimiting this winding layer IV in the first step as winding 5 with the number 42. Subsequently, this winding layer IV is completely filled out with windings 5 (with the numbers 42 through 45). It can be seen that the entry winding/winding 100 (number 1) and the exit winding/winding 101 (number 45) are arranged, at least in the Y direction, on the same side B of the main body 4.

The embodiment according to FIG. 10 is similar to the embodiment of FIG. 9. One difference consists in the outermost winding layer V and thereby the windings 5 with the numbers 37 through 39 being spaced away from both side sections 11, 12 or, in other words, have a free spacing, which is to say, a wire-free clearance, from both side sections 11, 12. This free spacing or alternatively this wire-free clearance can be at least one wire diameter 19, preferably at least two wire diameters 19, particularly preferably at least three wire diameters 19, most preferably at least four wire diameters 19, in its length.

The embodiment according to FIG. 12 is characterized in that in the third and in the fifth winding layer III, V a spacing section 28, 28′ is respectively formed by the windings 5 (with the numbers 43, 44 or alternatively 65, 66). The filling of these spacing sections 26, 26′ or alternatively gaps occurs in the case of the gap in the outermost winding layer V, by a winding 5 (number 69) originating from this winding layer V, and in the case of the gap in the third winding layer III, by a winding 5 (number 75) originating from the fourth winding layer IV. The embodiment of FIG. 12 is moreover characterized in that in a winding direction 36 along the axis 3 or alternatively along the direction of the Y axis of the main body 4, the winding layers II, IV are initially wound only partially (windings 5 with the numbers 25 through 41) and in an intermediate step the winding layers III or alternatively V wound on these winding layers II or alternatively IV are wound further (windings 5 with the numbers 42 through 75), prior to partial areas of these winding layers III or alternatively V which were wound initially in the winding direction 36 are wound further (windings 5 with the numbers 76 through 81) in a further advanced winding stage. At least one of these winding layers II, IV can be completely filled up during further winding or alternatively, in the final state, completely fill the spacing 26 (in axial direction) of the two side areas 11, 12 and/or has a spacing 16, 21 smaller than one wire diameter 19. The winding direction 36 can hereby preferably be directed in the direction of the narrower area of a cone-like or alternatively hollow truncated cone-like and/or hollow truncated pyramid-like winding volume or alternatively winding body 7.

The embodiment according to FIG. 11 comprises two spacing sections 28, 28′, which are filled by the windings 5 with the numbers 64 and 80. In this embodiment, the first and last winding 100, 101 are arranged at the same end region in the Y-direction, cf. arrow B, wherein this represents the area of the wider end portion of the winding body 7.

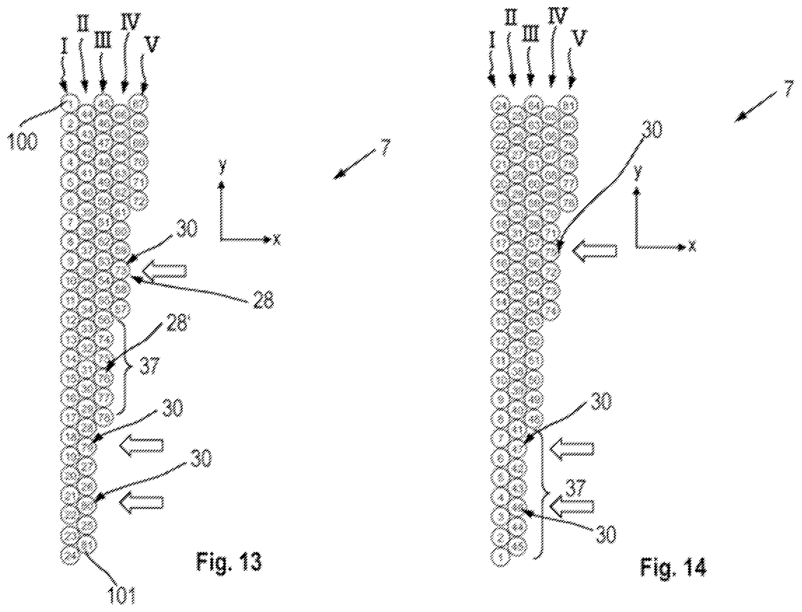

FIG. 13 shows an embodiment with three spacing sections 28, 28′, wherein the first and last winding 100, 101 are arranged at the same end in the Y-direction of the winding body 7, whereby this is the wider end of a winding body 7 having a conical or alternatively hollow-cylindrical and/or hollow-pyramidal shape. The winding body 7, moreover, has three spacing sections 28, 28′.

FIG. 14 shows an embodiment similar to FIG. 13, wherein the first and last winding 100, 101 are arranged at the narrower end region in the Y-direction of the winding body 7.

The two embodiments shown in FIG. 12, FIG. 13 each comprise first and second windings 100, 101 which are arranged on different sides in the Y-direction. The last winding 101 of each of these two embodiments is arranged in the second winding layer II. Since the length 37 of at least one stage 37, in particular the respective length 37 of all stages 37, of the cone-like or alternatively hollow truncated cone-like winding body 7 is more than four times the magnitude, in particular more than five times the magnitude of the length of the wire diameter 19, at least one spacing section 28 or alternatively one gap for receiving a filling winding 30 are respectively provided in at least one, preferably in at least two winding layer(s) II, IV. Preferably, both embodiments respectively comprise three spacing sections 28, 28′.

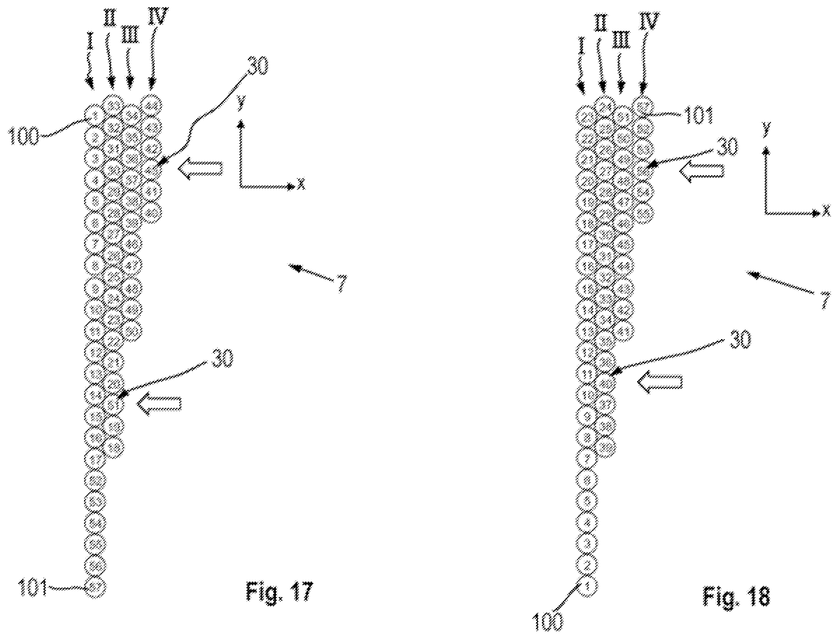

The embodiments shown in FIG. 15 through FIG. 18 respectively comprise an electrical component 1 or alternatively a winding body 7 with a total of four winding layers I, II, III, IV, wherein the first winding 100 is arranged in the first winding layer I and the last winding 101 is arranged in the fourth winding layer IV. In other words, in these embodiments, the first winding layer I forms the innermost winding layer I and the winding layer IV forms the outermost winding layer IV. According to the embodiments shown in FIG. 15 and FIG. 16, the first and last winding 100, 101 are arranged on the same side (cf. arrow B) of the main body 4 in the Y-direction. According to the embodiments shown in FIG. 17 and FIG. 18, the first and last winding 100, 101 are arranged on different sides of the main body 4 in the Y direction.

The innermost winding layer I of the embodiment shown in FIG. 15 comprises at least two spacing sections 28, 28′ or alternatively gaps in which are received the windings 5 with the numbers 55, 56 coming from or alternatively returned to the outer winding layers II, III, IV, in particular from the second winding layer II. According to the embodiment of FIG. 16, the spacing sections 28, 28′ formed there in the innermost winding layer I are filled by filling windings 30 coming from the same or alternatively from the innermost winding layer I.

A further feature of the embodiments according to FIG. 15 through FIG. 18 can, for example, be that the innermost winding layer I comprises an exposed section or alternatively a section that is not wound over (by a further outwardly situated winding layer II, III, IV). This exposed or alternatively section that is not wound over of the innermost winding layer I can, for example, amount to at least 5%, preferably at least 10%, particularly preferably at least 15%, most preferably at least 20%, of the length of the spacing 26 of the side sections 11, 12.

Alternatively or additionally, it may be provided that the first and the last winding 100, 101 of the electrical component 1, in particular of the winding body 7, are arranged in the same winding layer I, II, III, IV, V. As can be seen, for example, in the embodiments of FIG. 15 and FIG. 17, the first winding 100 and the last winding 101 of the wire can respectively be arranged in the first winding layer I. This enables a narrow construction or alternatively radially limited dimensions of the winding body 7. It can, moreover, be provided, for example, that the first and last winding 100, 101 of the electrical component 1, preferably of the winding body 7, arranged in the same, in particular in the innermost winding layer I, I are arranged on the same side (cf. arrow B). Thereby, as shown in FIG. 15 and FIG. 17, the first winding 100 and the last winding 101 of the electrical component 1, in particular of the winding body 7, can be arranged at the narrower end and/or at the end region facing the center 38 (cf. arrow B). In other words, the first and last winding 100, 101 are both arranged at the innermost winding layer I and at an end of the winding body 7 facing in the Y direction.

Another exemplary embodiment variant is shown in FIG. 8. The outermost winding layer V is thereby started by a winding 5 with the number 37 as the first winding 5 of this winding layer V. This first winding 5 or alternatively starter winding of the outermost winding layer V originates, in particular directly, from a filling winding 30 (with the number 36), which is arranged in a spacing section 28 or alternatively in a gap of a winding layer I, II, III, IV located further inside or alternatively closer to axis 3. Optionally, as shown, this spacing section 28 or alternatively the filling winding 30 can be covered or alternatively wound over in the final winding state by windings 5 of the outermost winding layer V, cf. windings 5 (with numbers 38 and 39). In other words, the embodiment according to FIG. 8 can comprise no filling winding 30 received in a spacing section 28 that is exposed or alternatively not wound over, which filling winding forms, in particular directly, the first winding 5 or alternatively starter winding for forming a winding layer II, III, IV, V lying further out, preferably the outermost winding layer V.

REFERENCE LIST

| | |
|---|---|
| 1 | Electrical component |
| 2 | Wire |
| 3 | Axis |
| 4 | Main body |
| 5 | Winding |
| 6, 6′ | Spacing between 3 and I, II, III, IV, V |
| 7 | Winding body |
| 8 | Engagement element |
| 9 | Mating element |
| 10 | Base section of 4 |
| 11 | Side section of 4 |
| 12 | Side section of 4 |
| 13 | Receiving volume of 4 |
| 14 | Boundary line |
| 15 | Limiting winding of the outer winding layer |
| 16 | Spacing between 15 and 11, 12 |
| 17 | Limiting winding of the inner winding layer |
| 18 | Spacing between 17 and 11, 12 |
| 19 | Diameter of 2 |
| 20 | Further delimiting winding of the outer winding layer |
| 21 | Spacing between 20 and 11, 12 |
| 22 | First group of 5 |
| 23 | Second group of 5 |
| 24 | Third group of 5 |
| 25 | Length of 22 and 24 |
| 26 | Spacing between 11, 12 |
| 27 | Intermediate winding layer |
| 28, 28′ | Spacing section |
| 29 | Spacing from 28 |
| 30 | Filling winding |
| 31 | Longitudinal side |
| 32 | First transverse side |
| 33 | Length of 31 |
| 34 | Length of 32, 40 |
| 35 | First transition section |
| 36 | Winding direction |
| 37 | Length of one stage |
| 38 | Center |
| 39 | Second transition section |
| 40 | Second transverse side |
| 51 through 58 | Winding pathway at end face |
| 100 | First winding of the 1 |
| 101 | Last winding of the 1 |
| A | Arrow |
| B | Arrow |
| X | Arrow |
| Y | Arrow |
| I, II, III, IV, | Winding layer |
| V, VI, VII | |

1. An electrical component, in particular an electrical coil, comprising a plurality of windings of a wire, which windings are wound on a main body that defines an axis, in particular a coil axis, wherein the windings are arranged in a plurality of winding layers which are at different spacings to the axis, wherein
at least one outer, in particular outermost, winding layer is wound on an inner winding layer laying closer to the axis of the main body, and
a first winding wound on the main body, in particular in direct contact with the main body, and the last winding wound on the main body are arranged on the same side of the main body.

2. The electrical component according to claim 1, wherein the main body has a base section running, in particular, substantially parallel to the axis of the main body, and side sections extending out from the base section substantially perpendicular to the axis of the main body, wherein a receiving volume for receiving the windings of the wire is formed by the side sections and the base section.

3. The electrical component according to claim 1, wherein at least one winding of the outer winding layer, in particular the outermost winding layer, delimiting the outer winding layer, in particular the outermost winding layer, has a greater spacing to at least one side section of the main body than at least one inner winding layer delimiting winding of the inner winding layer, preferably the spacing of the winding delimiting the outer winding layer of this winding layer to at least one side section is greater than or equal to a diameter of the wire forming this winding layer.

4. The electrical component according to claim 2, wherein a first winding of this winding layer delimiting the outer, in particular the outermost, winding layer which comprises a first spacing to the first side section of the main body and a further winding delimiting the outer, in particular the outermost, winding layer of this winding layer which comprises a second spacing to the further side section of the main body, preferably the first and the second spacing differ by at least the magnitude of the diameter of the wire.

5. The electrical component according to claim 1, wherein its wire is wound in such a way that
in a first step, a first group of windings arranged in the inner winding layer was wound
in a second step, a second group of windings arranged in the outer winding layer was wound, which second group was wound at least in sections, in particular completely, on the first group of windings arranged in the inner winding layer, and
in a third step, a third group of windings arranged in a winding layer located further inwards relative to the winding layer comprising the second group of windings, was wound.

6. The electrical component according to claim 5, wherein the first and the third group of windings are arranged in the same winding layer, with preferably a common axial length of at least 40% of the first and the further side section.

7. The electrical component according to claim 5, wherein the first and the third group of windings are arranged in the same winding layer and have a common axial length which corresponds to a maximum of 90% of the axial spacing of the first and the further side section.

8. The electrical component according to claim 1, wherein at least one intermediate winding layer is/are formed between the inner winding layer and the main body by windings of the wire, the inner winding layer is arranged at least in sections, in particular completely, directly on at least one intermediate winding layer.

9. The electrical component according to claim 1, wherein in at least one group of windings which are applied directly one after the other in at least one winding layer, at least two windings applied or alternatively wound one after the other form a spacing section in this winding layer, wherein the spacing section forms a spacing of at least one diameter of the wire.

10. The electrical component according to claim 9, wherein in the spacing section at least one or precisely one winding is arranged, wherein this winding, received in the spacing section, is led into the spacing section from a winding layer having a larger or smaller spacing to the axis than the winding layer having this spacing section.

11. The electrical component according to claim 9, wherein at least one or precisely one winding is arranged in the spacing section, wherein this winding received in the spacing section is led into the spacing section starting from the same winding layer as the winding layer comprising the spacing section.

12. The electrical component according to claim 1, wherein the at least one winding received in the spacing section spans over at least two windings.

13. The electrical component according to claim 1, wherein the main body comprises a base section, in particular running substantially parallel to the axis of the main body, which comprises an elongated cross-sectional basic shape with at least one longitudinal side and one transverse side, wherein the length of the longitudinal side is greater than the length of the transverse side by at least a factor of 1.20.

14. The electrical component according to claim 1, wherein at least one transition section of a winding guided from the outer winding layer into the inner winding layer is guided at least in sections, in particular exclusively, over a transverse side of the elongated main body.

15. The electrical component according to claim 1, wherein a first transition section of a winding guided from an outer winding layer into an inner winding layer is guided at least in sections, in particular exclusively, over a first transverse side of an elongated main body and a second transition section of a winding guided from an outer winding layer into an inner winding layer or from an inner winding layer into an outer winding layer is guided at least in sections, in particular exclusively, over a second transverse side, which is different from the first transverse side, and/or a longitudinal side of the elongated main body.

16. The electrical component according to claim 1, wherein a first transition section of a winding guided from an outer winding layer into an inner winding layer is guided at least in sections, in particular exclusively, over a first transverse side of an elongated main body and a second transition section of a winding guided from an outer winding layer into an inner winding layer or from an inner winding layer into an outer winding layer is guided at least in sections, in particular exclusively, over a first transverse side of an elongated main body.

17. A method of manufacturing an electrical component, in particular an electrical coil, according to claim 1.

18. An electrical assembly, in particular an electric motor, comprising at least one electrical component according to claim 1.
